(19) United States
(12) Patent Application Publication
(10) Pub. No.: US 2007/0190373 A1
(43) Pub. Date: Aug. 16, 2007

(54) SEPARATOR PLATE HAVING FUEL REFORMING CHAMBER FOR MCFC AND MANUFACTURING METHOD THEREOF

(75) Inventors: Jong-Seung PARK, Daejeon (KR); In-Gab CHANG, Daejeon (KR); Yun-Sung KIM, Daejeon (KR); Jeong-Seok YOO, Daejeon (KR); Boo-Ho YOON, Daejeon (KR); Bo-Hyun RYU, Daejeon (KR); Kil-Ho MOON, Daejeon (KR); Tae-Won LEE, Daejeon (KR)

Correspondence Address: CANTOR COLBURN, LLP, 55 GRIFFIN ROAD SOUTH, BLOOMFIELD, CT, 06002, US

(73) Assignee: DOOSAN HEAVY INDUSTRIES & CONSTRUCTION CO., LTD., Seoul (KR)

(21) Appl. No.: 11/673,233

(22) Filed: Feb. 9, 2007

(30) Foreign Application Priority Data
Feb. 10, 2006 (KR) 1020060013155

(51) Int. Cl. H01M 8/06; B01J 8/02; B05D 5/12; B21C 23/24

(52) U.S. Cl. 429/19; 429/38; 422/211; 427/115; 72/46

(57) ABSTRACT

The invention relates to a separator plate having a fuel reforming chamber for a molten carbonate fuel cell, which can be simply and easily manufactured to integrate the fuel reforming chamber, which enables indirect reforming, with a separator plate so as to realize uniform heat distribution of the separator plate, and to perform a fuel gas reforming reaction, which is an endothermic reaction, using heat generated during the operation of the fuel cell. According to the invention, a fuel gas such as methane (CH₄) is supplied to a fuel reforming chamber to reform it therein so as to convert it into hydrogen, after which the converted fuel gas is supplied between the fuel gas guides of an anode part positioned directly on the fuel reforming chamber, and at the same time, an oxidizing gas is supplied between the oxidizing gas guides positioned directly beneath the fuel reforming chamber, thus generating electricity.

This application claims the benefit of the filing date of Korean Patent Application No. 10-2006-0013155, filed on Feb. 10, 2006, in the Korean intellectual Property Office, the disclosure of which is incorporated herein its entirety by reference.

### BACKGROUND OF THE INVENTION

1. Field of the Invention

The present invention relates, generally, to a separator plate having a fuel reforming chamber for a molten carbonate fuel cell and a manufacturing method thereof. More particularly, the present invention relates to a separator plate having a fuel reforming chamber for a molten carbonate fuel cell, which can be simply and easily manufactured to integrate the fuel reforming chamber, which enables indirect reforming, with the separator plate so as to realize uniform heat distribution of the separator plate, to perform a fuel gas reforming reaction, which is an endothermic reaction, using heat generated during the operation of the fuel cell, and to have high reliability, and to a method of manufacturing the same.

2. Description of the Related Art

Fuel cells are receiving attention as a next-generation generator having high efficiency and generating little pollution for converting chemical energy into electrical energy through the oxidation-reduction reaction of reactants.

The fuel cell is essentially composed of an anode, a cathode, and an electrolyte matrix positioned between the anode and the cathode, in which an electrolyte is incorporated in the electrolyte matrix to assure efficient ion flow. That is, a fuel gas (e.g., hydrogen) is supplied into the anode to thus oxidize it, whereas oxygen or air is supplied into the cathode to reduce hydrogen ions (H⁺), which are transferred from the anode, and furthermore, the hydrogen ions are transferred through the electrolyte matrix positioned between the anode and the cathode, and, electrons flow via an external circuit. Thus, in the fuel cell, the chemical energy is directly converted into electrical energy through the oxidation-reduction reaction of hydrogen and oxygen. Accordingly, the fuel cell is advantageous in that it has high efficiency (since there is no limitation, like that of a Carnot cycle, which is characterized by low generation efficiency when mechanically generating heat by heating water or other media and rotating a turbine using steam pressure, as in typical heat generation), generates little pollution (since nitrogen oxide or sulfur oxide are not discharged), produces no noise (since there are no driving parts), can be made modular (since the fuel cell is easy to construct and enlarge and the capacity thereof may be variously formed), is compatible with a variety of fuels (since it is possible to use fuels such as hydrogen, coal gas, natural gas, methanol, and gasoline), and enables cogeneration (since warm water may be produced using waste heat in a high-temperature fuel cell). In particular, called a second generation fuel cell, a molten carbonate fuel cell (hereinafter, referred to as an “MCFC”) is characterized in that material, in which carbonate of alkali metal, such as lithium carbonate or potassium carbonate, is melted, is used as an electrolyte, and sintered nickel and sintered lithiated nickel oxide are used as a cathode and an anode, respectively. That is, a fast electrochemical reaction at high temperatures enables the use of inexpensive nickel, instead of platinum, as electrode material, thus generating economic benefits. Further, thanks to the properties of the nickel electrode, in which even carbon monoxide, which negatively affects the platinum electrode, may be used as fuel through a water gas shift reaction, various fuels, such as coal gas, natural gas, methanol, and biomass, may be selected. When good quality high-temperature waste heat is recovered using a heat recovery steam generator (HRSG), the total heat efficiency of the generation system may be increased to about 60% or higher. Furthermore, since the MCFC is operated at high temperatures, an electrochemical reaction and a fuel reforming reaction may simultaneously take place in a fuel cell stack to thus realize internal reforming. Since such an internal reforming MCFC functions to directly apply the heat value of the electrochemical reaction to a reforming reaction, which is an endothermic reaction, even without the use of an additional external heat exchanger, the total heat efficiency of the system is much higher than that of an external reforming MCFC, and furthermore, the structure of the system is simplified. The MCFC is composed largely of a stack for producing electricity, a mechanical peripheral device, such as a fuel supplier, and an electrical peripheral device, such as an electrical converter. In particular, since the stack affects the generation efficiency, lifetime, and performance of the MCFC, thorough research into the shapes of separator plates constituting the stack and methods of supplying fuel into the separator plate has been conducted. Despite these advantages of the MCFC, it is disadvantageous because it must be operated at high temperatures and uses highly corrosive molten carbonate as an electrolyte, undesirably leading to easy corrosion of the constituents of the cell. In particular, the separator plate should be provided with a cathode part, an anode part, and an electrolyte matrix therebetween, and a fuel gas and an oxidizing gas should separately flow in the separator plate, and thus the corrosion of the separator plate or the leakage from the separator plate very negatively affect the overall performance of the fuel cell. In addition, the separator plate of the MCFC should function to reform a fuel gas, such as natural gas or coal gas, which is continuously supplied, into hydrogen.

In a conventional separator plate, with the goal of completely separating the gas of the anode part from that of the cathode part, the end of the separator plate and the gas inlet and outlet of the manifold are welded using an Nd-YAG laser, and a wet seal area is subjected to corrosion-resistant coating using a mixture comprising aluminum, as a main ingredient, nickel, titanium, chromium, and copper, or using a ceramic material such as titanium nitride, and is then allowed to stand at 500˜600° C. for a predetermined time period in a reduction atmosphere or in a vacuum furnace, followed by performing heat treatment for forming an aluminum diffusion layer at an increased temperature of 700˜850° C. Since a hot-dip process, which is a conventional coating process, is difficult to use to mask an undesired portion and must be performed at high temperatures, the deformation of base metal undesirably occurs after using an aluminum melt. In addition, although a physical vapor deposition process enables the formation of a high quality coating layer, it suffers because the thickness of the layer is difficult to increase and the preparation cost thereof is very high. In addition, a pack cementation process may cause problems related to the deformation of a separator plate and the phase change of a base metal when work is conducted at 1000° C. or higher. Further, in the case of a thermal spray process, due to blasting for pretreatment or the pressure of a gun, a base metal may be deformed or pores may remain therein, and the thickness of the layer may be non-uniform. Furthermore, a slurry coating process is inexpensive and is easy to use to coat various shapes, but it is difficult to maintain the viscosity of the slurry, and thus the thickness uniformity is decreased, and also pores, resulting from solvent evaporation, are difficult to eliminate, and thereby the thickness of the coating layer is limited.

Further, the internal reforming MCFC, in which the fuel cell stack is filled with a reforming catalyst of methane-water vapor to thus directly use the produced hydrogen as a fuel, is advantageous because the manufacturing cost thereof is low, the heat value produced from the electrode reaction may be applied to the endothermic reforming reaction, and the hydrogen produced in a region neighboring the electrode is directly supplied to the reaction, thus making it possible to exhibit high fuel conversion efficiency. Widely known among conventional separator plates for MCFCs, an external distributing/internal reforming separator plate is disclosed in U.S. Pat. No. 6,200,696 B1. This separator plate is structured in such a manner that the outer side surface of a stack, for example, a distributing duct or a plenum chamber, is provided with a gasket to thus close it so as to form a space required for a reforming reaction, into which a fuel gas is then supplied to thus reform it, followed by supplying the reformed gas to an anode part. The separator plate thus has a simple structure, and therefore the manufacture and assembly thereof are easy. However, the above separator plate essentially requires cross-flow, in which the flow direction of the fuel gas supplied to the anode part crosses the flow direction of oxidizing gas supplied to the cathode part, and undesirably, the generation performance of such cross-flow is lower than that of co-flow (also referred to as “parallel flow”), in which the gas flow directions of the anode part and the cathode part are the same. In addition, as another conventional separator plate for an MCFC, an internal distributing/internal reforming separator plate is disclosed in US Patent Application Publication No. 20040151975 A1. Since each unit cell has an internal reforming separator plate including anode gas flow paths, cathode gas flow paths and reforming gas flow paths, which are capable of being formed using only a folding process without welding, the temperature increments may be minimized and the gas flow may be realized in the type of co-flow. However, the above separator is disadvantageous because it has a structure in which a plurality of manifold holes is formed through a wet seal area at the edge of the plate so that a fuel gas is supplied through the holes, undesirably resulting in a complicated form, low productivity due to manufacturing difficulties, and changes in height of the stack during operation thereof.

### SUMMARY OF THE INVENTION

Leading to the present invention, intensive and thorough research into separator plates, carried out by the present inventors, resulted in the development of a separator plate for an MCFC, having a fuel reforming chamber which enables indirect internal reforming using the center plate of the separator plate, which separates an anode and a cathode from each other.

Accordingly, an object of the present invention is to provide a separator plate having a fuel reforming chamber for an MCFC, which can be simply and easily manufactured to integrate the fuel reforming chamber, which enables indirect reforming with the separator plate so as to realize uniform heat distribution of the separator plate, to perform a fuel gas reforming reaction, which is an endothermic reaction, using heat generated during the operation of the fuel cell, and to have high reliability, and to a method of manufacturing the same.

In order to accomplish the above object, the present invention provides a separator plate having a fuel reforming chamber for an MCFC, comprising an anode part including a pair of fuel gas guides opposite each other, formed by twice folding each of two ends of a first rectangular metal plate, having a plurality of guide protrusions on a central portion thereof, toward the central portion of the first metal plate; a cathode part including a pair of oxidizing gas guides opposite each other, formed by twice folding each of two ends of a second rectangular metal plate, having a plurality of guide protrusions on a central portion thereof, toward the central portion of the second metal plate; and a fuel reforming chamber formed by folding a third rectangular metal plate into a shape of a hexahedron having two opposite open surfaces, wherein the anode part and the cathode part are aligned so that the fuel gas guides and the oxidizing gas guides have gas flows orthogonal to each other and so that the lower surfaces thereof face each other, and the fuel reforming chamber is positioned between the anode part and the cathode part to be integrated with either the anode part or the cathode part, and has a fuel gas inlet, a fuel gas outlet, and an inner surface which are coated with a reforming catalyst so as to reform a fuel gas while passing it therethrough.

The fuel reforming chamber may be integrated with the anode part.

The fuel reforming chamber may comprise a corner contact part formed by bringing two ends of the third metal plate into contact with each other to constitute any one corner of the hexahedron.

The fuel reforming chamber may comprise a line contact part formed by folding two ends of the third metal plate such that the two ends thereof come into contact with each other at any one metal wall surface of the hexahedron.

The fuel reforming chamber may further comprise a separator therein.

In addition, the present invention provides a method of manufacturing a separator plate having a fuel reforming chamber for an MCFC, comprising (1) an anode part shaping step of twice folding each of two ends of a first metal plate toward a central portion of the first metal plate, thus shaping an anode part having a pair of fuel gas guides opposite each other; (2) a cathode part shaping step of twice folding each of two ends of a second metal plate toward a central portion of the second metal plate, thus shaping a cathode part having a pair of oxidizing gas guides opposite each other; (3) a fuel reforming chamber shaping step of coating a surface of a third metal plate with a reforming catalyst for reforming a fuel gas, three times folding the third metal plate into a shape of a hexahedron which has two opposite open surfaces and in which two ends of the third metal plate are brought into contact with each other to constitute any one corner of the hexahedron to thus form a corner contact part, thereby forming a fuel reforming chamber, and attaching the corner contact part of the fuel reforming chamber to a corner of the anode part or the cathode part, which is positioned adjacent to the corner contact part of the fuel reforming chamber using a welding process; and (4) an alignment step of aligning the cathode part or the anode part, which is not attached to the fuel reforming chamber, with the fuel reforming chamber so that the fuel gas guides and the oxidizing gas guides have gas flows orthogonal to each other.

Furthermore, the present invention provides a method of manufacturing a separator plate having a fuel reforming chamber for an MCFC, comprising (1) an anode part shaping step of twice folding each of two ends of a first metal plate toward a central portion of the first metal plate, thus shaping an anode part having a pair of fuel gas guides opposite each other; (2) a cathode part shaping step of twice folding each of two ends of a second metal plate toward a central portion of the second metal plate, thus shaping a cathode part having a pair of oxidizing gas guides; (3) a fuel reforming chamber shaping step of coating a surface of a third metal plate with a reforming catalyst for reforming a fuel gas, four times folding the third metal plate into a shape of a hexahedron which has two opposite open surfaces and in which two ends of the third metal plate are brought into contact with each other at any one metal wall surface of the hexahedron to thus form a line contact part, thereby forming a fuel reforming chamber, and attaching corners of the fuel reforming chamber to corners of the anode part or the cathode part, which is positioned adjacent to the corners of the fuel reforming chamber, using a welding process; and (4) an alignment step of aligning the cathode part or the anode part, which is not attached to the fuel reforming chamber, with the fuel reforming chamber so that the fuel gas guides and the oxidizing gas guides have gas flows orthogonal to each other.

### BRIEF DESCRIPTION OF THE DRAWINGS

FIG. 1 is a perspective view schematically illustrating the structure of the separator plate having a fuel reforming chamber for an MCFC, according to the present invention;

FIG. 2 is an exploded perspective view illustrating the process of assembling the separator plate of FIG. 1;

FIG. 3 is a side sectional view taken along the line A-A of FIG. 2, which illustrates the fuel reforming chamber according to a first embodiment of the present invention;

FIG. 4 is a side sectional view taken along the line A-A of FIG. 2, which illustrates the fuel reforming chamber according to a second embodiment of the present invention;

FIG. 5 is a perspective view illustrating the fuel gas inlet of the fuel reforming chamber according to the present invention; and

FIG. 6 is a perspective view illustrating the fuel reforming chamber of FIG. 1, which further comprises a separator to reverse the flow of fuel gas.

### DESCRIPTION OF THE PREFERRED EMBODIMENTS

Hereinafter, a detailed description will be given of the embodiments of the present invention with reference to the appended drawings.

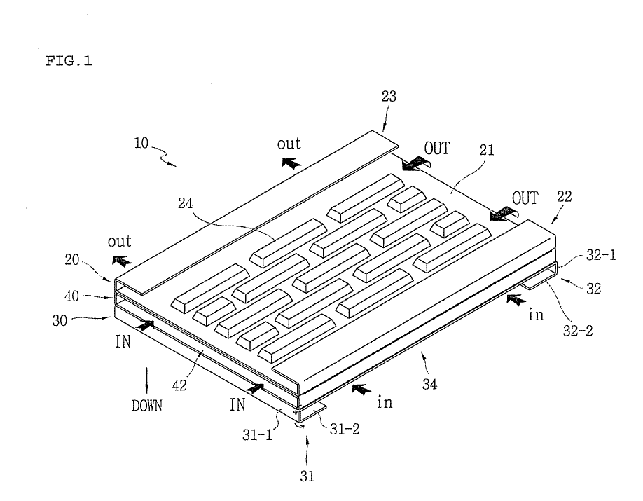

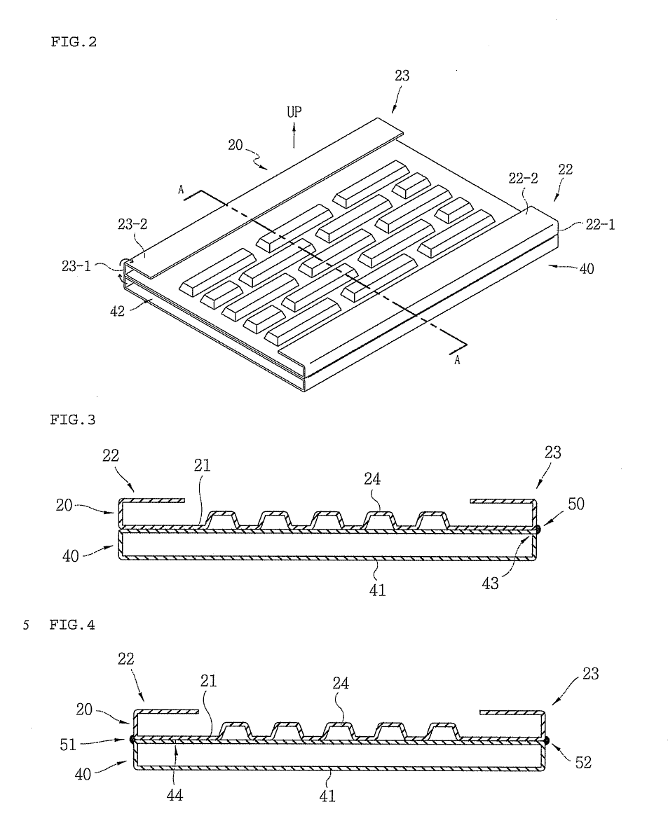

As illustrated in FIG. 1, the separator plate having a fuel reforming chamber for an MCFC according to the present invention comprises an anode part 20 including a pair of fuel gas guides 22, 23 which are opposite each other, formed by twice folding each of two ends of a first rectangular metal plate 21 having at least two guide protrusions 24 on the central portion thereof toward the central portion of the first metal plate 21; a cathode part 30 including a pair of oxidizing gas guides 31, 32 opposite each other, formed by twice folding each of two ends of a second rectangular metal plate having at least two guide protrusions on the central portion thereof toward the central portion of the second metal plate; and a fuel reforming chamber 40 formed by folding a third rectangular metal plate 41 three times to form the shape of a hexahedron having two opposite open surfaces. As such, the anode part 20 and the cathode part 30 are aligned so that the fuel gas guides 22, 23 and the oxidizing gas guides 31, 32 have gas flows orthogonal to each other and so that the lower surfaces thereof face each other. The fuel reforming chamber 40, which is positioned between the anode part 20 and the cathode part 30, is integrated with either the anode part 20 or the cathode part 30, and includes a fuel gas inlet 42, a fuel gas outlet, and the inner surface, which are coated with a reforming catalyst so as to reform a fuel gas while passing it therethrough. That is, a fuel gas, such as methane (CH₄), is supplied to the fuel reforming chamber 40 to reform it therein so as to convert it into hydrogen, after which the converted fuel gas is supplied between the fuel gas guides 22, 23 of the anode part 20, positioned directly on the fuel reforming chamber 40. At the same time, the oxidizing gas is supplied between the oxidizing gas guides 31, 32 of the cathode part 30, positioned directly beneath the fuel reforming chamber 40, thus generating electricity. As such, the fuel reforming chamber 40 is characterized in that it is integrated with the anode part 20 or the cathode part 30, and preferably, as seen in FIG. 2, with the anode part 20. In particular, according to the present invention, the fuel reforming chamber 40 is shaped to be integrated with the anode part 20, and therefore, the number of constituents, including the metal plate, of the fuel reforming chamber 40 and the number of parts to be welded are decreased, resulting in increased reliability and productivity.

As illustrated in FIG. 2, the anode part 20 is formed in such a manner that each of two ends of the first metal plate 21 is folded two times toward the central portion of the first metal plate 21, that is, the first surface 22-1 of the first metal plate 21 is perpendicularly folded upwards (in the direction represented by “UP” of FIG. 2) with respect to the first metal plate 21, and subsequently the second surface 22-2 is perpendicularly folded with respect to the first surface 22-1, thereby forming the first fuel gas guide 22. Further, in this manner, the first surface 23-1 of the first metal plate 21 is perpendicularly folded upwards with respect to the first metal plate 21, and then the second surface 23-2 is perpendicularly folded with respect to the first surface 23-1, thus forming the second fuel gas guide 23. Thereby, the fuel gas guides 22, 23 are formed in the shape of a rectangular bar so that the open portion of the first fuel gas guide 22 is opposite that of the second fuel gas guide 23, resulting in the anode part 20. In addition, an anode collector plate, an anode, and an electrolyte matrix are sequentially laminated in the upward direction (represented by “UP” in FIG. 2) of the anode part 20.

As illustrated in FIG. 1, the cathode part 30 is formed in such a manner that each of two ends of the second metal plate is folded two times toward the central portion of the second metal plate, that is, the first surface 31-1 of the second metal plate is perpendicularly folded downwards (in the direction represented by “DOWN” of FIG. 1) with respect to the second metal plate, and then the second surface 31-2 is perpendicularly folded with respect to the first surface 31-1, thus forming the first oxidizing gas guide 31. Further, in this manner, the first surface 32-1 of the second metal plate is perpendicularly folded downwards with respect to the second metal plate, and subsequently the second surface 32-2 is perpendicularly folded with respect to the first surface 32-1, thus forming the second oxidizing gas guide 32. Thereby, the oxidizing gas guides 31, 32 are formed in the shape of the rectangular bar so that the open portion of the first oxidizing gas guide 31 is opposite that of the second oxidizing gas guide 32, resulting in the cathode part 30. Furthermore, a cathode collector plate, a cathode, and an electrolyte matrix are sequentially laminated in the downward direction (represented by “DOWN” in FIG. 1) of the cathode part 30.

The fuel reforming chamber 40 is positioned between the anode part 20 and the cathode part 30, and preferably is integrated with the anode part 20. The inner surface of the fuel reforming chamber 40 is coated with a reforming catalyst. As such, the reforming catalyst functions to reform the fuel gas, which is supplied through the fuel gas inlet 42 and passes through the fuel reforming chamber 40. Thus, as seen in FIG. 1, the fuel gas is supplied through the fuel gas inlet 42 of the fuel reforming chamber 40, flows out the side opposite the fuel gas inlet, and is then supplied to the anode part 20 positioned on the fuel reforming chamber 40. Accordingly, the flow direction of the fuel gas before a reforming reaction is opposite that of the fuel gas in the anode part 20 after the reforming reaction, resulting in counter-flow. Alternatively, as seen in FIG. 6, a separator 60 is further provided in the fuel reforming chamber 40 to divide the fuel reforming chamber 40 into the upper portion and the lower portion, and the outlet opposite the fuel gas inlet 42 is closed, whereby the flow direction in the fuel reforming chamber 40 is converted into U-flow. Consequently, the flow direction of the fuel gas before the reforming reaction and the flow direction of the fuel gas in the anode part 20 after the reforming reaction result in co-flow in the same direction. The separator 60 may be used as a device for controlling the temperature of the hot spot in the fuel cell stack.

In the present invention, the term “reforming” means the conversion of a fuel gas into hydrogen (H₂) through thermal decomposition. Hydrogen is the simplest fuel gas and is converted into hydrogen ions through an oxidation-reduction reaction. The fuel gas is supplied into the anode to thus oxidize it, while oxygen or air is supplied into the cathode to reduce hydrogen ions (H⁺) transferred from the anode, and furthermore, the hydrogen ions are transferred through the electrolyte matrix between the anode and the cathode, and electrons flow via an external circuit, thus completing the cell reaction, resulting in the generation of electricity. The reforming efficiency of the fuel gas in the reforming chamber 40 is 30˜70% of the total amount of fuel gas supplied into the fuel reforming chamber 40, after which the remaining fuel gas is supplied into the anode part 20 from the fuel reforming chamber 40 so that it is reformed in the anode part 20. In such a case, the fuel gas is not 100% reformed, but about 99% of the total amount of the fuel gas supplied into the reforming chamber 40 is reformed, due to various operation factors.

The anode part 20 and the cathode part 30 are provided respectively on and beneath the fuel reforming chamber 40. As such, the anode part 20 and the cathode part 30 are aligned so that the fuel gas guides 22, 23 and the oxidizing gas guides 31, 32 have gas flows orthogonal to each other. Thus, the fuel reforming chamber 40 functions to perform a reforming reaction, which is an endothermic reaction, using heat generated from the fuel cell including the anode part 20 and the cathode part 30, and functions to decrease the heat distribution of the separator plate so as to uniformly control it.

The fuel reforming chamber 40 is formed, as seen in FIG. 3, in such a manner that the third metal plate 41 is folded three times into the shape of the hexahedron having two opposite open surfaces. As such, the fuel reforming chamber 40 includes a corner contact part 43 formed by bringing two ends of the third metal plate 41 into contact with each other to constitute any one corner of the hexahedron. Preferably, the corner contact part 43 is positioned in the upward direction of the fuel reforming chamber so that the corner contact part 43 is positioned adjacent to the corner of the anode part 20 to weld the corner contact part 43 of the fuel reforming chamber 40 together with the corner of the anode part 20. Thereby, the shaping of the fuel reforming chamber 40 and attachment thereof to the anode part 20 may be realized at the same time.

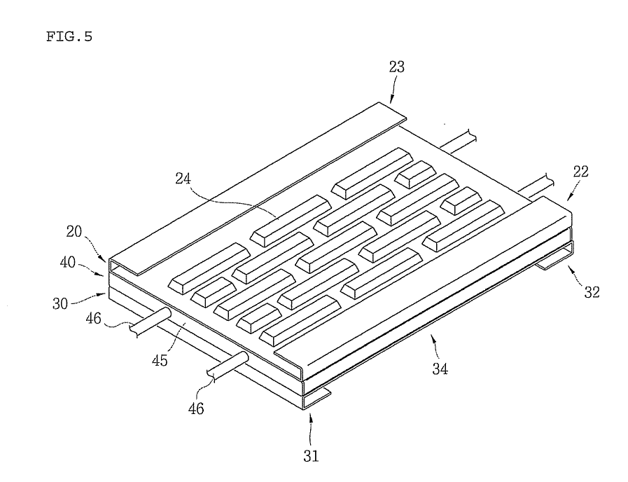

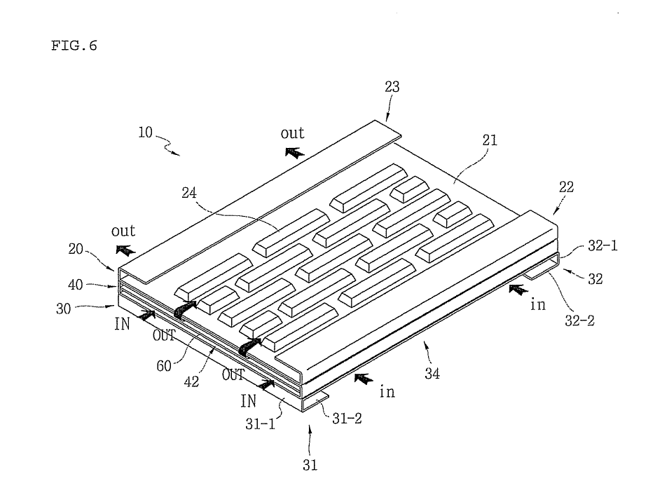

Alternatively, as seen in FIG. 4, the fuel reforming chamber 40 is formed in such a manner that the third metal plate is folded four times into the shape of a hexahedron having two opposite open surfaces. In this case, the fuel reforming chamber 40 includes a line contact part 44 formed by folding two ends of the third metal plate such that the two ends thereof come into contact with each other at any one metal wall surface of the hexahedron. Since the fuel reforming chamber 40 is formed using such a folding process, a conventional mold for a separator plate mold may be used as it is. Further, the line contact part 44 is tightly attached to the lower surface of the anode part 20 and thus does not require an additional welding process in order to assure airtightness for preventing the fuel gas from leaking therethrough. Both corners of the anode part 20 and the corners of the fuel reforming chamber 40, positioned directly therebeneath, are welded together, whereby the fuel reforming chamber 40 is attached to the anode part 20.

The central portion of the metal plate constituting each of the cathode part 30 and the anode part 20 is shaped to have at least two guide protrusions 24 such that the flow paths are distributed over the entire area of the separator plate. The protrusions function to allow the gas flow to be uniform so as to realize the uniform flow of gas (fuel gas in the anode part 20 or oxidizing gas in the cathode part 30) in the separator plate, thereby making it possible to uniformly maintain the heat distribution of the separator plate 10, heated using heat generated during the operation of the fuel cell.

In addition, the present invention provides the method of manufacturing the separator plate having the fuel reforming chamber for an MCFC, the method comprising (1) an anode part shaping step of twice folding each of two ends of a first metal plate 21 toward the central portion of the first metal plate 21, thus shaping an anode part 20 having a pair of fuel gas guides 22, 23 opposite each other; (2) a cathode part shaping step of twice folding each of two ends of a second metal plate toward the central portion of the second metal plate, thus shaping a cathode part 30 having a pair of oxidizing gas guides 31, 32 opposite each other; (3) a fuel reforming chamber shaping step of coating the surface of the third metal plate 41 with a reforming catalyst for reforming a fuel gas, three times folding the third metal plate into the shape of a hexahedron which has two opposite open surfaces and in which the two ends of the third metal plate 41 are brought into contact with each other to constitute any one corner of the hexahedron to thus form a corner contact part 43, thereby forming a fuel reforming chamber 40, and attaching the corner contact part 43 of the fuel reforming chamber 40 to the corner of the anode part 20 or the cathode part 30, which is positioned adjacent to the corner contact part 43, using a welding process; and (4) an alignment step of aligning the cathode part 30 or the anode part 20, which is not attached to the fuel reforming chamber 40, with the fuel reforming chamber 40 so that the fuel gas guides 22, 23 and the oxidizing gas guides 31, 32 have gas flows orthogonal to each other.

Alternatively, the present invention provides the method of manufacturing the separator plate having the fuel reforming chamber for an MCFC, the method comprising (1) an anode part shaping step of twice folding each of two ends of a first metal plate 21 toward the central portion of the first metal plate 21, thus shaping an anode part 20 having a pair of fuel gas guides 22, 23 opposite each other; (2) a cathode part shaping step of twice folding each of two ends of a second metal plate toward the central portion of the second metal plate, thus shaping a cathode part 30 having a pair of oxidizing gas guides 31, 32 opposite each other; (3) a fuel reforming chamber shaping step of coating the surface of a third metal plate 41 with a reforming catalyst for reforming a fuel gas, four times folding the third metal plate into the shape of a hexahedron which has two opposite open surfaces and in which the two ends of the third metal plate are brought into contact with each other at any one metal wall surface of the hexahedron to thus form a line contact part 44, thereby forming a fuel reforming chamber 40, and attaching the corners of the fuel reforming chamber 40 to the corners of the anode part 20 or the cathode part 30, which is positioned adjacent to the corners of the fuel reforming chamber 40, using a welding process; and (4) an alignment step of aligning the cathode part 30 or the anode part 20, which is not attached to the fuel reforming chamber 40, with the fuel reforming chamber 40 so that the fuel gas guides 22, 23 and the oxidizing gas guides 31, 32 have gas flows orthogonal to each other.

The anode part 20 and the cathode part 30 may be further subjected to nickel coating or corrosion resistant coating. The nickel coating or corrosion resistant coating may be easily performed using a known process, which will be easily understood by those skilled in the art. For example, the corrosion resistant coating is carried out using any one corrosion resistant material selected from among aluminum, nickel-aluminum and aluminum-titanium, thus increasing corrosion resistance. Such corrosion resistant coating is preferably performed using a known process, such as screen printing. The coating layer, resulting from a screen printing process, is preferably formed to a predetermined thickness ranging from 10 to 100 μm, depending on the vertical distance between the screen and the sidewall part.

Conventionally, since a reactive gas of an anode part is reformed using a reformer as an external peripheral device to thus produce hydrogen which is then supplied to a cell stack, the temperature gradient in the cell stack cannot be minimized, undesirably making it impossible to expect the cell to have a high performance and long lifetime. However, according to the present invention, the high operation temperature of the cell stack due to heat generated through the electrochemical reaction can be used as reactive heat required for the endothermic reforming reaction of water vapor, and thus, the increase in the temperature in the cell stack is prevented, and furthermore, the temperature gradient of the separator plate is minimized, consequently prolonging the lifetime of the fuel cell and improving the performance of the cell. Moreover, the system can be simplified without the use of an external reformer.

As described hereinbefore, the present invention provides a separator plate having a fuel reforming chamber for an MCFC and a manufacturing method thereof. According to the present invention, the separator plate having a fuel reforming chamber for an MCFC can be simply and easily manufactured to integrate the fuel reforming chamber, which enables indirect reforming, with the separator plate so as to realize uniform heat distribution of the separator plate, to perform a fuel gas reforming reaction, which is an endothermic reaction, using heat generated during the operation of the fuel cell, and to have high reliability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A separator plate having a fuel reforming chamber for a molten carbonate fuel cell, comprising:
an anode part including a pair of fuel gas guides opposite each other, formed by twice folding each of two ends of a first rectangular metal plate, having a plurality of guide protrusions on a central portion thereof, toward the central portion of the first metal plate;
a cathode part including a pair of oxidizing gas guides opposite each other, formed by twice folding each of two ends of a second rectangular metal plate, having a plurality of guide protrusions on a central portion thereof, toward the central portion of the second metal plate; and
a fuel reforming chamber formed by folding a third rectangular metal plate into a shape of a hexahedron having two opposite open surfaces,
wherein the anode part and the cathode part are aligned so that the fuel gas guides and the oxidizing gas guides have gas flows orthogonal to each other and so that the lower surfaces thereof face each other, and the fuel reforming chamber is positioned between the anode part and the cathode part to be integrated with either the anode part or the cathode part, and has a fuel gas inlet, a fuel gas outlet, and an inner surface which are coated with a reforming catalyst so as to reform a fuel gas while passing it therethrough.

2. The separator plate of claim 1, wherein the fuel reforming chamber is integrated with the anode part.

3. The separator plate of claim 1, wherein the fuel reforming chamber comprises a corner contact part formed by bringing two ends of the third metal plate into contact with each other to constitute any one corner of the hexahedron.

4. The separator plate of claim 1, wherein the fuel reforming chamber comprises a line contact part formed by folding two ends of the third metal plate such that the two ends thereof come into contact with each other at any one metal wall surface of the hexahedron.

5. The separator plate of claim 1, wherein the fuel reforming chamber further comprises a separator therein.

6. A method of manufacturing a separator plate having a fuel reforming chamber for a molten carbonate fuel cell, comprising:
(1) an anode part shaping step of twice folding each of two ends of a first metal plate toward a central portion of the first metal plate, thus shaping an anode part having a pair of fuel gas guides opposite each other;
(2) a cathode part shaping step of twice folding each of two ends of a second metal plate toward a central portion of the second metal plate, thus shaping a cathode part having a pair of oxidizing gas guides opposite each other;
(3) a fuel reforming chamber shaping step of coating a surface of a third metal plate with a reforming catalyst for reforming a fuel gas, three times folding the third metal plate into a shape of a hexahedron which has two opposite open surfaces and in which two ends of the third metal plate are brought into contact with each other to constitute any one corner of the hexahedron to thus form a corner contact part, thereby forming a fuel reforming chamber, and attaching the corner contact part of the fuel reforming chamber to a corner of the anode part or the cathode part, which is positioned adjacent to the corner contact part of the fuel reforming chamber, using a welding process; and
(4) an alignment step of aligning the cathode part or the anode part, which is not attached to the fuel reforming chamber, with the fuel reforming chamber so that the fuel gas guides and the oxidizing gas guides have gas flows orthogonal to each other.

7. A method of manufacturing a separator plate having a fuel reforming chamber for a molten carbonate fuel cell, comprising:
(1) an anode part shaping step of twice folding each of two ends of a first metal plate toward a central portion of the first metal plate, thus shaping an anode part having a pair of fuel gas guides opposite each other;
(2) a cathode part shaping step of twice folding each of two ends of a second metal plate toward a central portion of the second metal plate, thus shaping a cathode part having a pair of oxidizing gas guides;
(3) a fuel reforming chamber shaping step of coating a surface of a third metal plate with a reforming catalyst for reforming a fuel gas, four times folding the third metal plate into a shape of a hexahedron which has two opposite open surfaces and in which two ends of the third metal plate are brought into contact with each other at any one metal wall surface of the hexahedron to thus form a line contact part, thereby forming a fuel reforming chamber, and attaching corners of the fuel reforming chamber to corners of the anode part or the cathode part, which is positioned adjacent to the corners of the fuel reforming chamber, using a welding process; and
(4) an alignment step of aligning the cathode part or the anode part, which is not attached to the fuel reforming chamber, with the fuel reforming chamber so that the fuel gas guides and the oxidizing gas guides have gas flows orthogonal to each other.

8. The separator plate of claim 2, wherein the fuel reforming chamber comprises a corner contact part formed by bringing two ends of the third metal plate into contact with each other to constitute any one corner of the hexahedron.

9. The separator plate of claim 2, wherein the fuel reforming chamber comprises a line contact part formed by folding two ends of the third metal plate such that the two ends thereof come into contact with each other at any one metal wall surface of the hexahedron.

10. The separator plate of claim 2, wherein the fuel reforming chamber further comprises a separator therein.
